(19) United States
(12) Patent Application Publication
(10) Pub. No.: US 2011/0216334 A1
(43) Pub. Date: Sep. 8, 2011

(54) IMAGE PROCESSING DEVICE, IMAGE FORMING APPARATUS AND IMAGE PROCESSING METHOD

(75) Inventor: Hiromasa Tanaka, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/038,668

(22) Filed: Mar. 2, 2011

Related U.S. Application Data
(60) Provisional application No. 61/310,479, filed on Mar. 4, 2010.

(51) Int. Cl. G06F 15/00

(52) U.S. Cl. 358/1.9

(57) ABSTRACT

An image processing device includes a memory and a controller. The memory stores a first profile and a second profile. The first profile represents a correspondence relationship between RGB value of image data and color space data of an image printed on a sheet in correspondence with the image data. The second profile represents a correspondence relationship between the RGB value of the image data that is input to a display unit, and the color space data of the image displayed on the display unit. The controller specifies the color space data corresponding to the RGB value of the image data to be printed with the aid of the first profile, specifies the RGB value corresponding to the color space data specified by the first profile with the aid of the second profile, and uses the RGB value specified by the second profile as display data of the display unit.

### CROSS-REFERENCE TO RELATED APPLICATION(S)

This application is based upon and claims the benefit of priority from: U.S. provisional application 61/310,479, filed on Mar. 4, 2010; the entire contents of which are incorporated herein by reference.

### FIELD

Embodiments described herein relate to an image processing device and an image processing method.

### BACKGROUND

When a scanner reads an original document, and a print is conducted on the basis of a read image, color conversion is conducted according to a color space duplicatable by a printer. The duplicatable color space may be varied according to an environment of usage and individual variability of the printer, and colors of a printed image may be different from colors assumed by a user.

### DESCRIPTION OF THE DRAWINGS

FIG. 1 is a diagram illustrating an outline of an image forming apparatus;

FIG. 2 is a diagram illustrating an outline of a scanner;

FIG. 3 is a block diagram illustrating a circuit configuration that processes an image;

FIG. 4 is a block diagram illustrating a configuration of a system part;

FIG. 5 is a flowchart showing a process of displaying an image read by the scanner on a display unit in a first embodiment;

FIG. 6 is a flowchart showing a process of acquiring a first profile;

FIG. 7 is a diagram illustrating a display example of a display unit in a control panel;

FIG. 8 is a diagram illustrating a system including a PC and the image forming apparatus in a second embodiment; and

FIG. 9 is a flowchart showing a process of displaying an image on a display unit before printing the image in the second embodiment.

### DETAILED DESCRIPTION

According to embodiments, an image processing device includes a memory and a controller. The memory stores a first profile and a second profile therein. The first profile represents a correspondence relationship between RGB value of image data and color space data of an image printed on a sheet in correspondence with the image data. The second profile represents a correspondence relationship between the RGB value of the image data that is input to the display unit, and the color space data of the image displayed on the display unit. The controller specifies the color space data corresponding to the RGB value of the image data to be printed with the aid of the first profile, specifies the RGB value corresponding to the color space data specified by the first profile with the aid of the second profile, and uses the RGB value specified by the second profile as display data of the display unit.

### First Embodiment

An image forming apparatus 100 has a plurality of paper cassettes 101 each contains a plurality of sheets therein. The plurality of sheets contained in each paper cassette 101 passes through a paper path, and is supplied to an image forming unit 102. The image forming unit 102 forms a toner image on the sheet on the basis of the image data. The image data includes, for example, image data transmitted to the image forming apparatus 100 from an external device (for example, personal computer), or image data generated by read operation of the scanner 103.

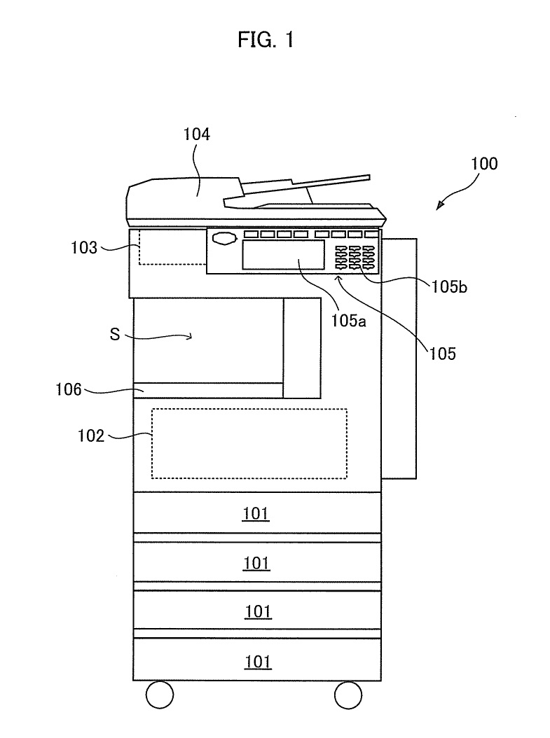

The scanner 103 scans an image of the original document to generate the image data. FIG. 1 illustrates a part of the scanner 103. A device (ADF: auto document feeder) 104 that automatically feeds the original document to the scanner 103 is disposed above the scanner 103.

A control panel 105 is disposed on an upper portion of the image forming apparatus 100. The control panel 105 is used to input a variety of information to the image forming apparatus 100, and display a variety of information. The control panel 105 has a display unit 105a and button switches 105b.

The display unit 105a displays a color image thereon. If a so-called touch panel display unit is used as the display unit 105a, specific information can be input, or specific information can be displayed by the display unit.

The image forming unit 102 forms an electrostatic latent image corresponding to the image data on a photosensitive surface of a photoreceptor, and thereafter supplies toner thereto to form a toner image. The image forming unit 102 transfers the toner image formed on the surface of the photoreceptor onto a sheet. The image forming unit 102 brings the sheet into contact with the surface of the photoreceptor so as to transfer the toner image onto the sheet. Alternatively, after transferring the toner image on the photoreceptor onto an intermediate transfer belt, the image forming unit 102 can transfer the toner image onto the sheet from the intermediate transfer belt.

The image forming unit 102 fixes the toner image on the sheet by heating through a fixing unit. The sheet on which the toner image has been fixed passes through the paper path, and arrives at a sheet output space S. A sheet output tray 106 for stacking the sheets thereon is disposed in the sheet output space S.

In this embodiment, the image forming apparatus 100 as a digital multifunction peripheral is equipped with the scanner 103. This embodiment is applicable to a case in which an image forming apparatus as the digital multifunction peripheral is equipped with the scanner, and a case in which a product is made up of only the scanner. This embodiment is also applicable to an image forming apparatus that discharges an ink to form an image.

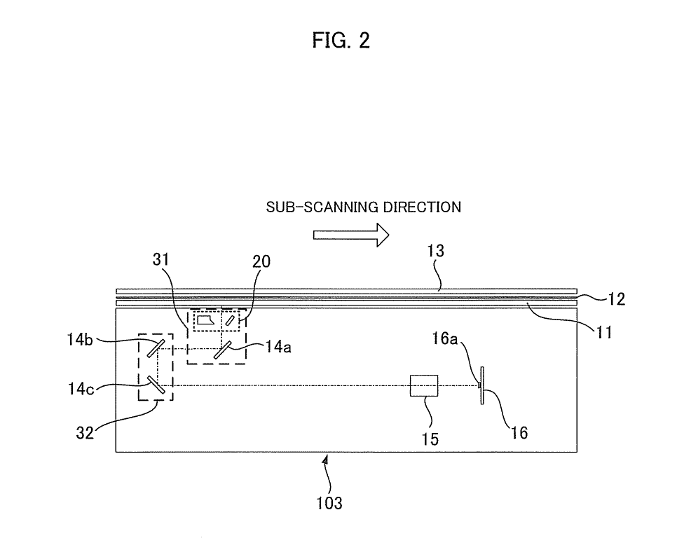

A configuration of the scanner 103 will be described with reference to FIG. 2. FIG. 2 is a cross-sectional view of the scanner 103 along a sub-scanning direction.

An original document 12 is put on an upper surface of a platen glass 11, and a read surface of the original document 12 contacts the upper surface of the platen glass 11. A platen cover 13 rotates with respect to a main body of the scanner 103, and opens the upper surface of the platen glass 11 or closes the upper surface of the platen glass 11. If the platen cover 13 is closed, the original document 12 is pushed against the platen glass 11 by the platen cover 13. The platen cover 13 forms a part of the ADF 104.

An illumination unit 20 illuminates the original document 12 with an illumination light. The illumination unit extends in a direction (a main scanning direction) orthogonal to a paper plane of FIG. 2, and emits a linear illumination light extending in a longitudinal direction of the illumination unit 20. The illumination unit 20 irradiates an image area of the original document 12 for one line extending in the main scanning direction with the linear illumination light.

The illumination light of the illumination unit 20 is reflected by the original document 12. The reflected light from the original document 12 is reflected by return mirrors 14a, 14b, and 14c, and goes toward an imaging lens 15. The imaging lens 15 condenses a light from the return mirror 14c to image the light on an image sensor 16. The image sensor 16 has a plurality of light receiving elements 16a arrayed in a direction orthogonal to the paper plane of FIG. 2. The plurality of light receiving elements 16a is arranged in correspondence with the linear illumination light, and receives the linear illumination light. Each of the light receiving elements 16a subjects the light to photoelectric conversion, and outputs an electric signal corresponding to an incident quantity of light. The image sensor 16 can be formed of, for example, a CCD sensor.

The reflected light from the original document 12 is input to the plurality of light receiving elements 16a so that the scanner 103 can read the image area of the original document 12 for one line extending in the main scanning direction.

A first carriage 31 supports the illumination unit 20 and the return mirror 14a, and moves in the sub-scanning direction. A second carriage 32 supports the return mirrors 14b, and 14c, and moves in the sub-scanning direction. The first carriage 31 and the second carriage 32 move relatively in the sub-scanning direction, and maintain a constant optical path length from a surface (reflected surface of the illumination light) of the original document 12 to the imaging surface of the image sensor 16.

With movement of the first carriage 31 and the second carriage 32, scanning can be conducted with the illumination light of the illumination unit 20 in the sub-scanning direction. While the first carriage 31 and the second carriage 32 are moving in the sub-scanning direction, the scanner 103 sequentially reads the image area of the original document 12 for one line extending in the main scanning direction. The scanner 103 can read the entire surface of the original document 12.

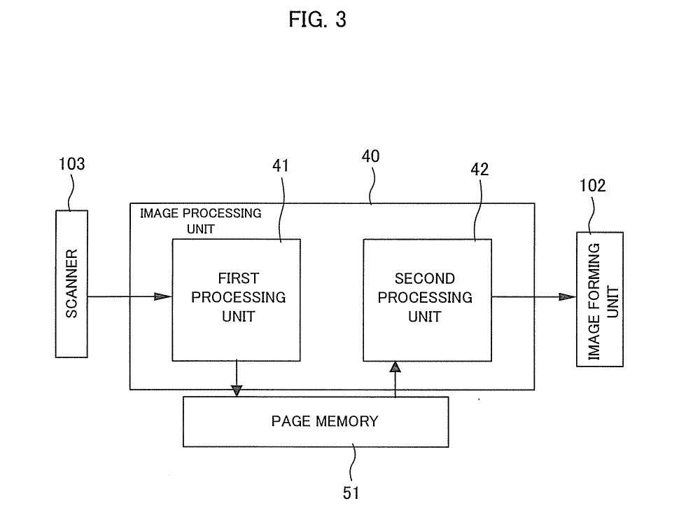

FIG. 3 illustrates a circuit configuration for conducting image processing on image data generated by the scanner 103. The scanner 103 outputs the generated image data to an image processing unit 40. The image processing unit 40 has a first processing unit 41 and a second processing unit 42. The first processing unit 41 conducts image processing on the image data from the scanner 103. The image processing is, for example, image rotation, filtering, color conversion, halftone processing, and gamma correction. The first processing unit 41 outputs processed data to a page memory 51. The second processing unit 42 receives data from the page memory 51, and converts the image data into a printable format. The second processing unit 42 outputs converted data to the image forming unit 102.

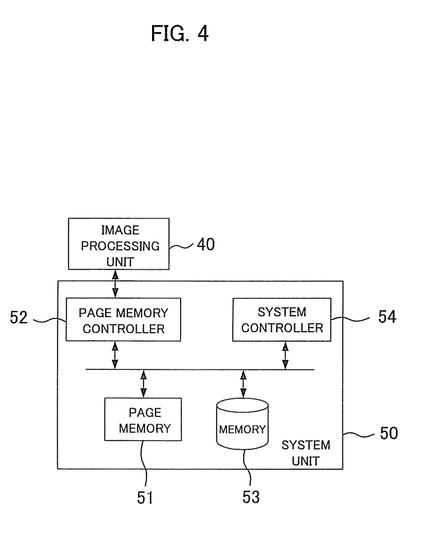

As illustrated in FIG. 4, the image processing unit 40 communicates with a system unit 50. The system unit 50 includes the page memory 51, a page memory controller 52, a memory 53, and a system controller 54.

The page memory controller 52 stores data from the image processing unit 40 in the page memory 51, and outputs data within the page memory 51 to the image processing unit 40. The system controller 54 controls the operation of the image forming apparatus 100.

The operation of the image forming apparatus 100 will be partially described. In the operation of the image forming apparatus 100, the image read by the scanner 103 is displayed on the display unit 105a of the control panel 105. The image display (preview display) of the display unit 105a is conducted before the image read by the scanner 103 is printed on a sheet.

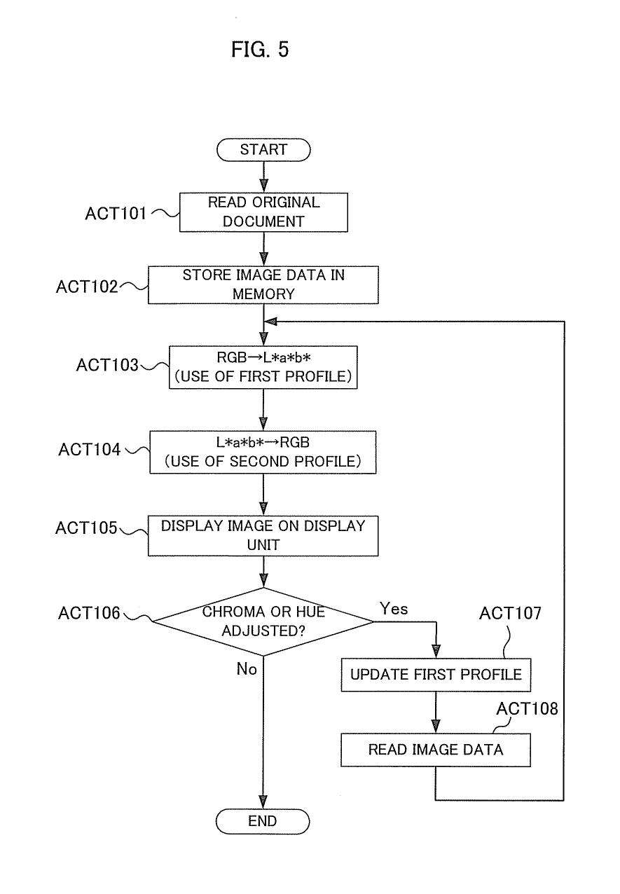

FIG. 5 is a flowchart showing the operation of the image forming apparatus 100.

Processing shown in FIG. 5 is realized by allowing a processor incorporated into the system controller 54 to execute a program stored in the memory 53.

The scanner 103 reads an image of the original document 12 (ACT 101). The system controller 54 controls the operation of the scanner 103. The system controller 54 stores the image data generated by the scanner 103 in the memory 53 (ACT 102).

The system controller 54 converts the image data (RGB signal) generated by the scanner 103 into an L*a*b* value (color space data) with the aid of a first profile (ACT 103).

The first profile represents a correspondence relationship between the L*a*b* value obtained by colorimetry of the image formed on the sheet by the image forming apparatus 100, and the image data (RGB signal) generated by reading the image formed on the sheet by the image forming apparatus 100, by the scanner 103. The image to be subjected to colorimetry is the same as the image read by the scanner 103.

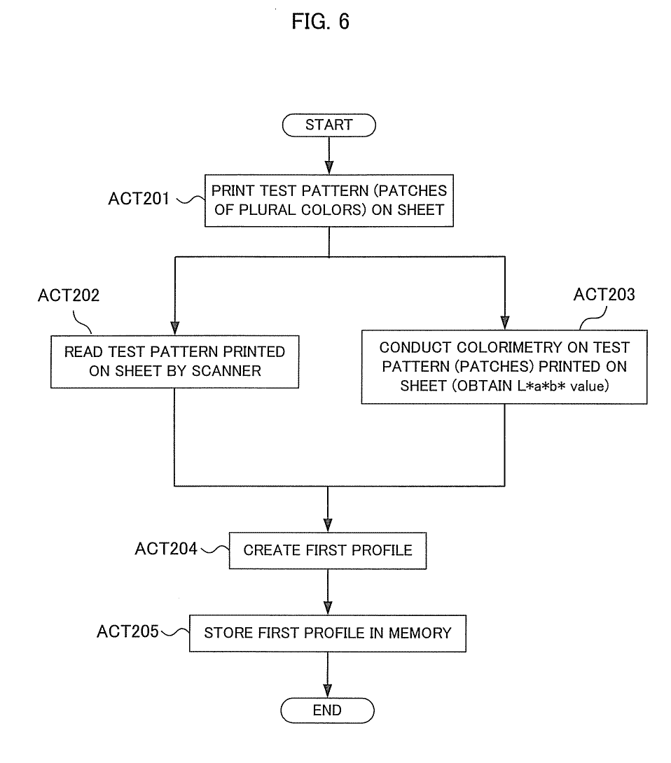

A method of acquiring the first profile will be described with reference to FIG. 6.

A test pattern is printed on the sheet with the aid of the image forming apparatus 100 (ACT 201). The test pattern includes patches of plural colors. Colors used in the test pattern can be appropriately set. A patch of one color can be printed on the sheet.

The test pattern formed on the sheet is read with the aid of the scanner 103 (ACT 202). The image data (RGB signal) generated by the scanner 103 corresponds to the test pattern formed on the sheet to obtain the RGB value corresponding to patches of the respective colors.

The colorimetry of the test pattern formed on the sheet is conducted with the aid of a spectrocolorimeter (ACT 203). The spectrocolorimeter irradiates the sheet with a colorimetric light source (for example, D50) to measure spectroscopic characteristics. Because the test pattern includes the patches of the plural colors, colorimetry is conducted in correspondence with the patch of each color. The L*a*b* value can be acquired by colorimetry of the test pattern.

The first profile is created with the aid of the RGB value obtained by processing of ACT 202, and the L*a*B* value obtained by processing of ACT 203 (ACT 204). Because processing of ACTS 202 and 203 is conducted on an identical image (test pattern), the RGB value obtained by processing of ACT 202 and the L*a*b* value obtained by processing of ACT 203 correspond to each other. The first profile is data in which the RGB value is associated with the L*a*b* value. The correspondence relationship between the RGB value and the L*a*b* value is created according to the patch of each color.

The first profile is stored in the memory 53 (ACT 205). The system controller 54 reads the first profile stored in the memory 53 to conduct processing of ACT 103. In processing of ACT 103, the system controller 54 specifies the L*a*b* value corresponding to the RGB value generated by the scanner 103 with reference to the first profile.

The system controller 54 converts the L*a*b* value obtained by processing of ACT 103 into the RGB value with the aid of the second profile (ACT 104). The second profile specifies the color characteristics of the display unit 105a, and represents a correspondence relationship between the RGB value and the L*a*b* value. If the display color of the display unit 105a is measured, the L*a*b* value on the display of the display unit 105a can be acquired. If the acquired L*a*b*c* value is associated with the RGB value of the display unit 105a, the second profile is created. The second profile can be stored in the memory 53.

The system controller 54 specifies the RGB value corresponding to the L*a*b* value acquired in processing of ACT 103 with reference to the second profile (ACT 104)

The system controller 54 displays the image on the display unit 105a on the basis of the RGB value acquired in ACT 104 (ACT 105)

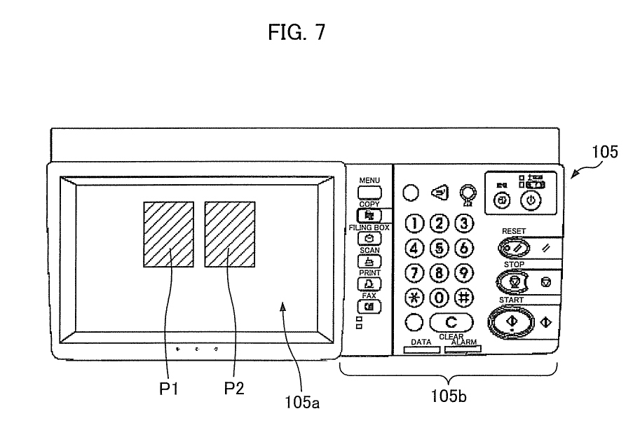

As illustrated in FIG. 7, the display unit 105a can display two images P1 and P2 side by side. The image P1 is an image when the image data generated by the scanner 103 is output to the display unit 105a and displayed on the display unit 105a. The image P1 is irrelevant to the first profile and the second profile. The image P2 is an image when the image data generated by the scanner 103 is converted with the aid of the first profile and the second profile, and the converted data is displayed on the display unit 105a.

A user can compare the image P1 and the image P2 by viewing the display unit 105a.

The system controller 54 discriminates whether chroma and hue are adjusted, or not (ACT 106). The user operates the control panel 105 so as to adjust chroma and hue of the image displayed on the display unit 105a.

When the user operates the control panel 105 to adjust chroma and hue (yes in ACT 106), the system controller 54 updates the first profile. If the user adjusts at least one of chroma and hue, the system controller 54 updates the first profile according to the adjusted results.

The system controller 54 updates the first profile according to the adjusted results of chroma and hue. The updated first profile can be stored in the memory 53. From the next time, the converted first profile can be used.

The system controller 54 reads the image data stored in the memory 53 in processing of ACT 102. The system controller 54 specifies the L*a*b* value corresponding to the read image data (RGB value) with the aid of the updated first profile.

After the L*a*b* value is specified, the system controller 54 converts the L*a*b* value into the RGB value with the aid of the second profile (ACT 104), and displays the image on the display unit 105a with the aid of the converted RGB value (ACT 105). The user can confirm the image in which adjustment of chroma and hue is completed on the display of the display unit 105a.

When the user does not adjust chroma and hue, the image remains displayed on the display unit 105a.

In this embodiment, chroma and hue of the image displayed on the display unit 105a can be adjusted; however, processing of ACT 106 can be omitted.

In this embodiment, the display image on the display unit 105a is determined on the basis of the RGB value corresponding to the L*a*b* value with reference to the L*a*b* value of the image formed on the sheet. Accordingly, colors of the image formed on the sheet can be made identical with colors of the image displayed on the display unit 105a. The user views the display image on the display unit 105a so as to confirm the colors of the image formed on the sheet before the image is formed on the sheet.

The vision of the image read by the scanner 103 may be different depending on the brightness of the display unit 105a. When the image read by the scanner 103 is displayed on the display unit 105a, it is preferable that the brightness of the display unit 105a is set to a reference value. When the brightness of the display unit 105a is changed by setting of the user, the system controller 54 can return the brightness of the display unit 105a to the reference value before the image read by the scanner 103 is displayed on the display unit 105a.

### Second Embodiment

In the first embodiment, the image read by the scanner 103 is displayed on the display unit 105a of the control panel 105 disposed on the image forming apparatus 100. In this embodiment, when the image data to be printed is transmitted to the image forming apparatus 100 from a PC (personal computer) through a network, and then printed, a print image is displayed on the PC before print is conducted.

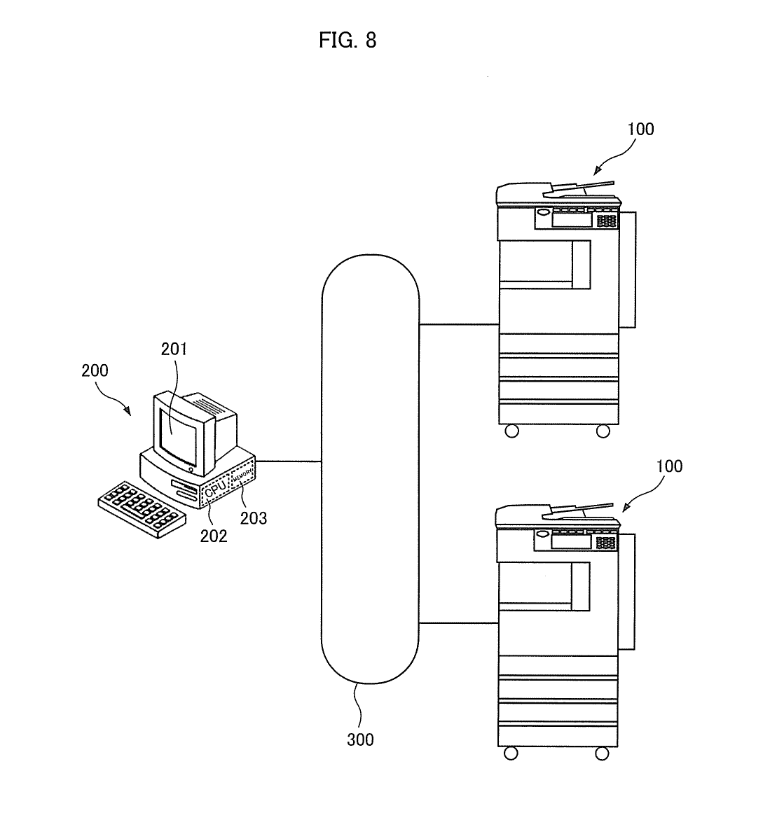

FIG. 8 is a schematic diagram of a system including an image forming apparatus 100 and a PC 200.

A PC 200 is connected to a plurality of image forming apparatuses 100 through a network 300. A user of the PC 200 can select an arbitrary image forming apparatus 100 from the plurality of image forming apparatuses, and transmit image data (print job) to be printed to the image forming apparatus 100.

The PC 200 has a display unit 201 that displays a variety of information. The display unit 201 displays the image data to be printed. The PC 200 includes a CPU 202 that controls the operation of the PC 200 and a memory 203 that stores a variety of information therein.

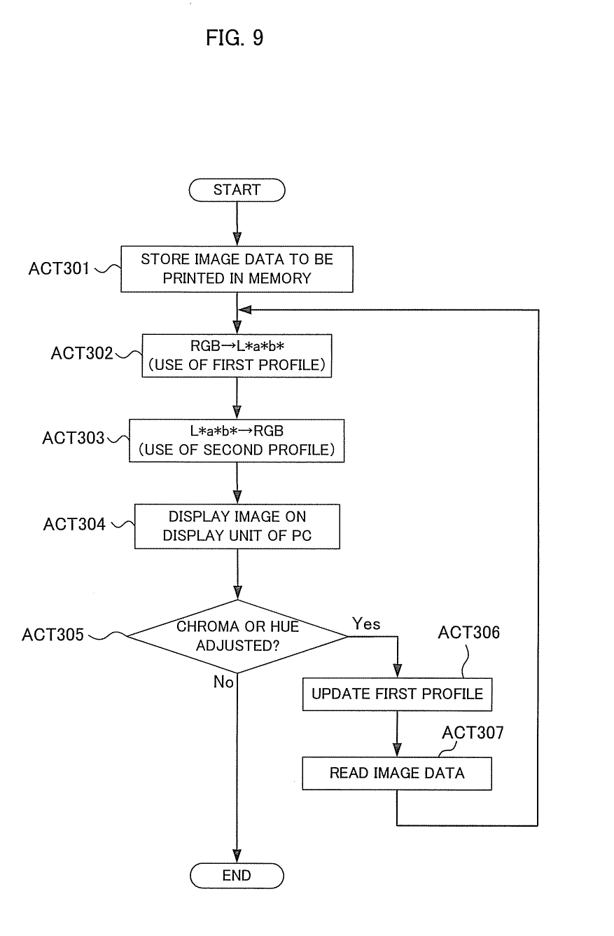

FIG. 9 is a flowchart showing the operation of the PC 200 according to this embodiment. Processing in FIG. 9 is realized by allowing a processor incorporated into the CPU 202 to execute a program stored in the memory 203.

The CPU 202 stores the image data to be printed in the memory 203 (ACT 301). The CPU 202 converts image data (RGB value) to be printed into an L*a*b* value with the aid of the first profile (ACT 302).

The first profile represents a correspondence relationship between the L*a*b* value obtained by colorimetry of the image formed on the sheet by the image forming apparatus 100, and the image data (RGB value) input to the image forming apparatus 100. The first profile can be obtained by the same method as that in the first embodiment. The first profile is different depending on the image forming apparatus 100. The CPU 202 can acquire the first profile from a printer driver.

The CPU 202 converts the L*a*b* value obtained by processing of ACT 302 into the RGB value (ACT 303) with the aid of the second profile. As the second profile, data indicative of color characteristics of the display unit 201 is used. The second profile related to the display unit 201 is obtained by measuring a relationship between the L*a*b* value of the display color in the display unit 201 and the RGB value in the display unit 201 in advance.

The CPU 202 displays the image on the display unit 201 on the basis of the RGB value obtained in ACT 303 (ACT 304). The user views the image displayed on the display unit 201 so as to confirm the colors of the image printed on the sheet before the image is printed on the sheet.

When the display unit 201 displays the image, the user can adjust chroma and hue of the display image. As in the first embodiment, if the user adjusts chroma and hue of the display image (yes in ACT 305), the CPU 202 updates the first profile (ACT 306), and reads the image data stored in the memory 203 (ACT 307). The CPU 202 can specify the L*a*b* value corresponding to the RGB value with respect to the read image data (RGB value) with the aid of the updated first profile (ACT 302).

In this embodiment, a configuration in which the image data is transmitted to the image forming apparatus 100 from the PC 200 is described. However, a configuration in which the image data is transmitted to the image forming apparatus 100 from an external device other than the PC 200 is also applicable to this embodiment. The external device only needs to have a display unit that can display the print image of colors.

In this embodiment, the PC 200 conducts processing shown in FIG. 9. Alternatively, the processing shown in FIG. 9 can be conducted by the image forming apparatus 100. When the image forming apparatus 100 conducts the processing shown in FIG. 9, the image forming apparatus 100 needs to acquire information on the second profile from the PC 200.

The programs for executing the processing described in FIGS. 5 and 9 are stored in the memories 53 and 203 incorporated into the image forming apparatus 100 and the PC 200, respectively, in advance. The programs can be also dealt with by other means. For example, the programs can be downloaded into the image forming apparatus 100 or the PC 200 from a network, or stored in a recording medium readable by a computer.

The recording medium may be a recording medium that can store the programs and be readable by the computer. The recording medium includes, for example, an internal storage device internally installed in the computer, such as a ROM or a RAM, a portable storage medium such as a CD-ROM, a flexible disc, a DVD disc, a magneto optical disc, or an IC card, a database that holds a computer program, other computers or databases thereof, or a transmission medium on a line.

The function obtained by installation or download may be realized in cooperation with an OS (operating system) of the image forming apparatus. The program may be an execution module in which a part or all of program is dynamically generated. At least a part of various processing realized by allowing the processor to execute the program can be executed by an ASIC (application specific integrated circuit) in a circuit manner.

While certain embodiments have been described, these embodiments have been presented by way of example only, and are not intended to limit the scope of the inventions . Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device, comprising:
a memory that stores a first profile and a second profile, the first profile representing a correspondence relationship between an RGB value of image data and color space data of an image printed on a sheet in correspondence with the image data, and the second profile representing a correspondence relationship between the RGB value of the image data that is input to a display unit, and the color space data of the image displayed on the display unit; and
a controller that specifies the color space data corresponding to the RGB value of the image data to be printed with the aid of the first profile, specifies the RGB value corresponding to the color space data specified by the first profile with the aid of the second profile, and uses the RGB value specified by the second profile as display data of the display unit.

2. The device according to claim 1,
wherein the controller specifies the color space data corresponding to the RGB value of the image data output from a scanner that reads an image of an original document with the aid of the first profile.

3. The device according to claim 1,
wherein the controller updates the first profile upon receiving an instruction for changing at least one of chroma and hue of the image displayed on the display unit.

4. The device according to claim 1,
wherein the display unit is a display unit that is disposed in an image forming apparatus which prints the image.

5. The device according to claim 1,
wherein the display unit is a display unit disposed on an external device that transmits image data to be printed to an image forming apparatus.

6. The device according to claim 1,
wherein the color space data is an L*a*b* value.

7. An image forming apparatus, comprising:
a scanner that reads an image;
an image forming unit that forms the image on a sheet on the basis of image data generated by the scanner;
a display unit that displays the image to be formed on the sheet;
a memory that stores a first profile and a second profile, the first profile representing a correspondence relationship between an RGB value of the image data and color space data of the image printed on the sheet in correspondence with the image data, and the second profile representing a correspondence relationship between the RGB value of the image data that is input to the display unit, and the color space data of the image displayed on the display unit; and
a controller that specifies the color space data corresponding to the RGB value of the image data with the aid of the first profile, specifies the RGB value corresponding to the color space data specified by the first profile with the aid of the second profile, and uses the RGB value specified by the second profile as display data of the display unit.

8. The apparatus according to claim 7,
wherein the display unit displays at least one of information on operation of the image forming apparatus, and input information for operating the image forming apparatus.

9. The apparatus according to claim 7,
wherein the display unit displays an image when the first profile and the second profile are used, and an image when the first profile and the second profile are not used, side by side.

10. The apparatus according to claim 7,
wherein the controller updates the first profile upon receiving an instruction for changing at least one of chroma and hue of the image displayed on the display unit.

11. The apparatus according to claim 7,
wherein the color space data is an L*a*b* value.

12. An image processing method, comprising:
specifying color space data corresponding to an RGB value of image data to be printed with the aid of a first profile representing a correspondence relationship between the RGB value of the image data and the color space data of an image printed on a sheet in correspondence with the image data;
specifying the RGB value corresponding to the color space data specified by the first profile with the aid of a second profile representing a correspondence relationship between the RGB value of the image data that is input to the display unit, and the color space data of the image displayed on the display unit; and
using the RGB value specified by the second profile as display data of the display unit.

13. The method according to claim 12, further comprising
specifying the color space data corresponding to the RGB value of the image data output from a scanner that reads an image of an original document with the aid of the first profile.

14. The method according to claim 12, further comprising
updating the first profile upon receiving an instruction for changing at least one of chroma and hue of the image displayed on the display unit.

15. The method according to claim 12, further comprising
inputting the RGB value used as the display data to a display unit disposed in an image forming apparatus which prints the image.

16. The method according to claim 12, further comprising
inputting the RGB value used as the display data to a display unit in an external device that transmits the image data to be printed to an image forming apparatus.

17. The method according to claim 12,
wherein the color space data of the first profile is data obtained by conducting colorimetry on the image formed on the sheet.

18. The method according to claim 12,
wherein the color space data of the second profile is data obtained by conducting colorimetry on the image displayed on the display unit.

19. The method according to claim 12,
wherein the color space data is an L*a*b* value.
